(19) United States
(12) Patent Application Publication
(10) Pub. No.: US 2020/0336661 A1
(43) Pub. Date: Oct. 22, 2020

(54) VIDEO RECORDING AND PROCESSING METHOD AND ELECTRONIC DEVICE

(71) Applicant: Lenovo (Beijing) Co., Ltd., Beijing (CN)

(72) Inventors: Xing ZHANG, Beijing (CN); Cong LI, Beijing (CN)

(21) Appl. No.: 16/855,696

(22) Filed: Apr. 22, 2020

(30) Foreign Application Priority Data
Apr. 22, 2019 (CN) 201910327045.2

(51) Int. Cl. H04N 5/232; H04N 5/77; H04N 5/225

(52) U.S. Cl. CPC H04N 5/23245; H04N 5/772; H04N 5/2258; H04N 5/23216; H04N 5/23293

(57) ABSTRACT

A video processing method includes receiving video recording instructions; determining a recording mode as a current recording mode from two recording modes based on an ambient light parameter during a video recording process, the two recording modes corresponding to different camera arrangements of the electronic device; obtaining images captured by a camera corresponding to the current recording mode; and displaying based on the obtained images.

### CROSS-REFERENCE TO RELATED APPLICATION

This application claims priority to Chinese Patent Application No. 201910327045.2, filed on Apr. 22, 2019, the entire content of which is incorporated herein by reference.

### TECHNICAL FIELD

The present disclosure relates to the technical field of electronics and, more particularly, to a video processing method, a processing device, and an electronic device.

### BACKGROUND

With the development of science and technology, an electronic device such as a smartphone, a tablet, a notebook computer, etc., becomes a tool that is essential in people's daily life. Among many functions of the electronic devices such as smartphones, tablets, etc., video recording is one of the most important functions. To improve the quality of recording, many electronic devices are configured with two or more cameras. However, when using a camera to record a video, often only one of the cameras is being used. The electronic device often cannot adjust the recording according to reference factors such as the light of recording environment. Under a harsh recording condition, such as in a dark space, the quality of recording is poor.

### SUMMARY

Embodiments of the present disclosure provide a processing method. The method includes receiving video recording instructions; determining a recording mode as a current recording mode from two recording modes based on an ambient light parameter during a video recording process, the two recording modes corresponding to different camera arrangements of the electronic device; obtaining images captured by a camera corresponding to the current recording mode; and displaying based on the obtained images.

Embodiments of the present disclosure provide a video processing device. The video processing device includes an instruction circuit, configured to receive video recording instructions; and a recording circuit, configured to respond to the video recording instructions during a video recording process to: determine a recording mode as a current recording mode from two recording modes based on an ambient light parameter, the two recording modes correspond to different camera arrangements of the device; obtain images captured by a camera corresponding to the current recording mode; and display based on the obtained images.

Embodiments of the present disclosure provide an electronic device including two cameras; processors; and a memory, configured to store programs that, when executed by the processors, cause the processors to: receive video recording instructions; and respond to the video recording instructions during a video recording process to: determine a recording mode as a current recording mode from two recording modes based on an ambient light parameter, the two recording modes corresponding to different camera arrangements; obtain images captured by a camera corresponding to the current recording mode; and display based on the obtained images.

### BRIEF DESCRIPTION OF THE DRAWINGS

FIG. 1 illustrates an application scenario of a processing method according to some embodiments of the present disclosure;

FIG. 2 illustrates a flowchart of the processing method according to some embodiments of the present disclosure;

FIG. 3 illustrates a schematic diagram of video frame images of a video recording process according to some embodiments of the present disclosure;

FIG. 4 illustrates a block diagram of a processing device according to some embodiments of the present disclosure; and

FIG. 5 illustrates a block diagram of an electronic device according to some embodiments of the present disclosure.

### DETAILED DESCRIPTION OF THE EMBODIMENTS

Embodiments of the present disclosure are described by referring to the accompanying drawings. The description is merely illustrative and does not limit the scope of the present disclosure. To facilitate explanation, many details are described to provide comprehensive understanding of embodiments of the present disclosure. One or a plurality of embodiments can also be implemented without these specific details. In addition, descriptions of well-known structures and techniques are omitted to avoid unnecessarily obscuring the concepts of the present disclosure.

Terms used in the present specification are merely for describing specific embodiments, but do not intent to limit the present disclosure. The terms of “including,” “containing,” etc., indicate existences of features, operations, and/or components, but do not exclude existences or additions of one or more other features, operations, or components.

All terms used herein (including technical and science terms) have the meaning commonly understood by those skilled in the art, unless otherwise defined. The terms used here should be interpreted as having a meaning consistent with the context of this specification and should not be interpreted ideally or overly stereotypically.

When using an expression similar to “at least one of A, B, or C,” etc., in general, it should be interpreted according to the meaning generally understood by those skilled in the art (for example, “having at least one of the devices such as A, B, or C ” shall include, but not limited to, devices with A alone, B alone, C alone, A and B, A and C, B and C, and/or A, B, and C, etc.).

The accompanying drawings show some block diagrams and/or flowcharts. Some blocks or combinations of the blocks of the block diagrams and/or flowcharts can be implemented by computer program instructions. The computer program instructions can be provided to a general-purpose computer, a special purpose computer, or a processor of another programmable data processing device. As such, these instructions can be executed by the processor to create a device for implementing functions/operations described in these block diagrams and/or flowcharts. The technology of the present disclosure may be implemented in form of hardware and/or software (including firmware, microcode, etc.). In addition, the technology of the preset disclosure may be a computer program product by storing the instructions in a computer-readable storage medium. This computer program product can be used by or in conjunction with an instruction execution system.

Embodiments of the present disclosure provide a processing method. The method includes receiving video recording instructions, and responding to the video recording instructions during a video recording process. Responding to the video recording instructions includes determining one recording mode as a current recording mode from at least two recording modes based on an ambient light parameter, obtaining images captured by a camera corresponding to the current recording mode, and displaying based on the obtained images. Different recording modes correspond to different camera arrangements of the electronic device.

The processing method provided by embodiments of the present disclosure, during the video recording process of an electronic device, can switch to a different recording mode in real time according to changes of the ambient light parameter. The different recording mode may correspond to a camera of a different type and/or a different quantity. As such, during the video recording process, the method can better adapt to a recording environment, achieve a better video recording quality, and improve user experience.

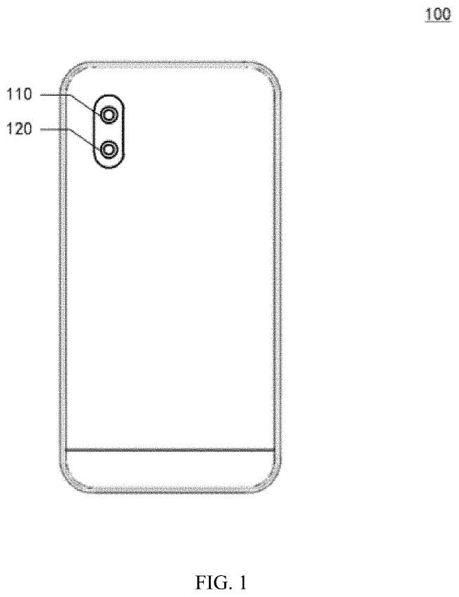

FIG. 1 illustrates an application scenario of a processing method according to some embodiments of the present disclosure. FIG. 1 shows only an example that implements the processing method of embodiments of the present disclosure. This example helps those skilled in the art understand technical contents of the present disclosure, but does not suggest that embodiments of the present disclosure cannot be used in other devices, environments, or scenarios.

As shown in FIG.1, smartphone 100 uses the processing method of embodiments of the present disclosure. Smartphone 100 is configured with at least two cameras 110 and 120. Cameras 110 and 120 are placed at a same surface of the smartphone 100 and have a same recording direction. For example, both recording directions of the cameras are nearly perpendicular to a back surface of smartphone 100. The cameras record toward areas at the back of smartphone 100. Parameters of camera 110 and camera 120 are different. The two cameras have different recording qualities. The parameters include a resolution, a size of a photosensitive element, a signal-to-noise ratio, etc. For example, camera 110 may have a higher resolution than camera 120 with a low photosensitivity. Camera 120 may have a low resolution but has a strong photosensitivity.

Based on the processing method of embodiments of the present disclosure, smartphone 100 may select different recording modes according to the ambient light parameters during the video recording process. Different recording modes may correspond to cameras of different types and of different quantities. For example, a first recording mode may correspond to camera 110, a second recording mode may correspond to camera 120, or the second recording mode may correspond to camera 110 and camera 120 simultaneously. During the video recording process, the ambient light parameter may indicate that the ambient light is relatively bright, for example, smartphone 100 is in an outdoor environment during daytime and the ambient light incident to the camera is sufficient. Accordingly, smartphone 100 can use the first recording mode to obtain images captured by camera 110. The ambient light parameter may indicate that the ambient light is relative dark, for example, smartphone 100 is in the outdoor environment during evening time or is entering into a dark indoor environment, and the ambient light incident to the camera is insufficient. Accordingly, smartphone 100 may switch to the second recording mode to obtain images captured by camera 120, or obtains images captured by camera 110 and camera 120 simultaneously, and merges the images captured by camera 110 and camera 120. As such, smartphone 100 may achieves a better video recording quality.

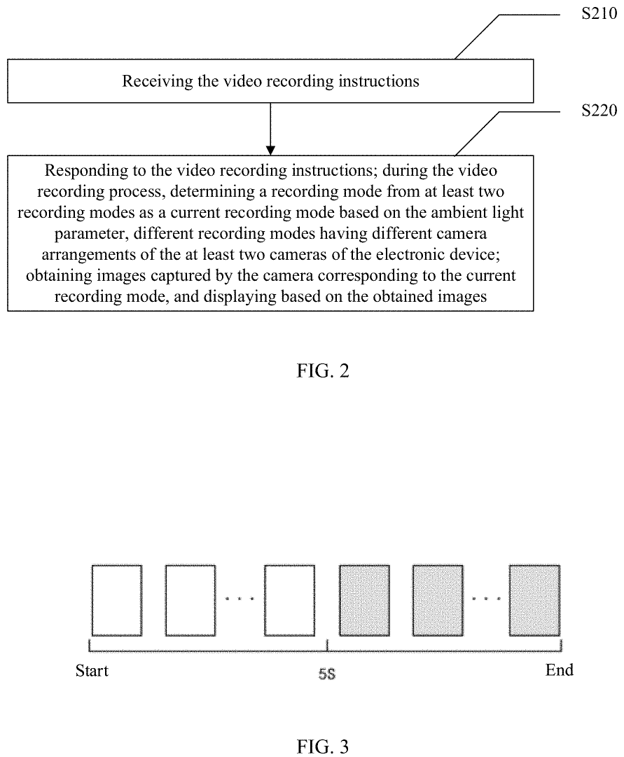

FIG. 2 illustrates a flowchart of the processing method according to some embodiments of the present disclosure.

As shown in FIG. 2, the processing method may include obtaining the video recording instructions at S210, and responding to the video recording instructions at S220 during the video recording process. Responding to the video recording instructions includes determining a recording mode from the at least two recording modes as a current recording mode based on the ambient light parameter, obtaining images captured by the camera corresponding to the current recording mode, and displaying based on the obtained images. Different recording modes correspond with different cameras and camera arrangements of the electronic device.

In some embodiments, receiving the video recording instructions includes receiving the video recording instructions executed by a user on a camera application software.

In some embodiments, the electronic device obtains the ambient light parameter through an operation of the user. The electronic device may determine ambient light information based on the user operating the electronic device. For example, a virtual button of a “dark mode” is placed at a video recording interface of a camera application, which is similar to a virtual button of a “flash.” The user operates the electronic device to turn on or turn off the dark mode. In some embodiments, the ambient light parameter may be an on/off status of the dark mode. If the dark mode is off, the ambient light brightness is relatively bright. If the dark mode is on, the ambient light brightness is relatively dark. The on status or off status of the dark mode corresponds to different recording modes. For example, when the dark mode is off, the electronic device uses the first recording mode as the current recording mode. When the dark mode is on, the electronic device uses the second recording mode as the current recording mode.

In other embodiments of the present disclosure, the electronic device can also obtain the ambient light parameter through a detection of the photosensitive element. The photosensitive element can detect a brightness of an environment. In some embodiments, the ambient light parameter may be the brightness of the ambient light. The ambient light brightness of different ranges may correspond to different recording modes. For example, when the ambient light brightness is larger than a brightness threshold, the electronic device uses the first recording mode as the current recording mode. When the ambient light brightness is smaller than a brightness threshold, the electronic device uses the second recording mode as the current recording mode. During the video recording process, the photosensitive element may detect the ambient light brightness at pre-determined time intervals.

In some embodiments, the different recording modes correspond to different cameras and camera arrangements of the electronic device may refer to the different types and/or quantities of the camera corresponding to the different recording modes. For example, the types of the first camera and the second camera may be different. The first camera is a camera with a high resolution. The second camera is a camera with a high photosensitivity. The first recording mode corresponds to the first camera, and the second recording mode corresponds to the second camera. In some embodiments, the first recording mode corresponds to the first camera, and the second recording mode corresponds to the first camera and the second camera.

In some embodiments, a recording mode corresponding to a camera arrangement means that under the recording mode, only the camera corresponding to this recording mode is working. That is, the electronic device only uses the corresponding camera to capture images, and the other camera is in low-power status, e.g., off or standby.

In some embodiments, a recording mode corresponding to a camera arrangement further means that under the recording mode, a plurality of cameras are working and can obtain images. However, only images captured by the camera corresponding to the current recording mode are used in subsequent processing. Images captured by other cameras are lost.

In some embodiments, during the video recording process, the ambient light parameter is different at different moments, thus the electronic device can activate different recording modes at the corresponding moment. During the video recording process, the electronic device may also only use one recording mode to complete the video recording without switching the recording modes. During the video recording process, as the ambient light parameter changes, the electronic device switches the recording modes one or more times and uses the at least two recording modes to complete the video recording. For example, during the whole process of the video recording, the detected ambient light brightness may be greater than the brightness threshold, and the ambient light may be sufficient. Thus, the whole recording process can only use the first recording mode to complete the video recording. In another example, at the beginning of the video recording, the dark mode is off, the electronic device may determine the first recording mode as an initial recording mode. At one moment, for example, five seconds after the video recording starts, the electronic device may turn the dark mode on and switch to the second recording mode.

The electronic device obtains the images captured by the camera corresponding to the current recording mode. Based on the obtained images, the electronic device may display and generate a video file.

FIG. 3 illustrates a schematic diagram of video frame images of a video recording process according to some embodiments of the present disclosure.

As shown in FIG. 3, white images indicate video frame images obtained by using the first recording mode. Gray images indicate video frame images obtained by using the second recording mode. The first half portion of the video recording uses the first recording mode. The electronic device receives a plurality of video frame images captured by the camera corresponding to the first recording mode in sequence. The electronic device processes sequentially the received video frame images accordingly and displays sequentially the processed video frames images on the display interface of the electronic device. At a moment during the video recording process, for example, five seconds after the video recording starts, the electronic device turns the dark mode on and uses subsequently the second recording mode. Thus, the electronic device receives the plurality of video frame images captured by the camera corresponding to the second recording mode in sequence. The electronic device processes received video frame images accordingly and displays sequentially the processed video frames images on the display interface of the electronic device until the video recording ends. At the same time, the electronic device generates a video file based on each frame image obtained by processing during the video recording. When the video file is re-opened subsequently, the electronic device displays the video frame images stored in the video file in a time sequence.

In some embodiments, based on the ambient light parameter during the video recording process, the electronic device switches among different recording modes. As such, the video file generated by responding to the recording instructions includes the video frame images corresponding to the different recording modes.

For example, during a video recording process, the on/off status of the dark mode changes, or the change of the detected ambient light brightness exceeds the brightness threshold. The ambient light brightness changes from lower than the brightness threshold to higher than the brightness threshold, or changes from higher the than the brightness threshold to lower than the brightness threshold. For these changes of the ambient light parameter, the electronic device switches the recording modes accordingly. If the electronic device uses the at least two recording modes during the video recording process, the video file corresponding to this video recording includes the video frame images corresponding to the at least two different recording modes.

In some embodiments, images obtained at the different recording modes have certain differences. For example, sharpness and brightness are different. When switching the recording modes, a direct transition between the two frame images before and after the switching may cause certain visual discomfort. Therefore, the electronic device performs blur processing to the two frame images before and after the switching, and transits from one recording mode to another recording mode more naturally.

In some embodiments, during the video recording process, the electronic device may not switch the recording mode. For example, the dark mode is off or on during the whole process. In some embodiments, the ambient light brightness monitored during the whole process is lower than the brightness threshold or higher than the brightness threshold. Therefore, the video file corresponding to the video recording only includes the video frame images corresponding to one recording mode.

In some embodiments, the at least two recording modes include the first recording mode and the second recording mode. The first recording mode corresponds to the first camera of the at least two cameras. The first camera has a higher resolution than the second camera of the at least two cameras. The second recording mode corresponds to the second camera. The second camera may have a larger pixel dimension than the first camera.

In some embodiments, the electronic device includes the first camera and the second camera. The first camera and the second camera, for example, may be rear cameras of the electronic device. The first camera has the higher resolution but has a smaller pixel dimension. The first camera has the high resolution but poor photosensitivity. The second camera has a lower resolution but a larger pixel dimension. The second camera has the strong photosensitivity but the low resolution. Thus, the first camera is suitable for use in an environment with sufficient light. The second camera is suitable for use in an environment with insufficient light.

During the video recording process, when the ambient light parameter indicates a dark ambient light environment, the electronic device may activate the second recording mode and only uses the second camera to record or only receives the video frame images captured by the second camera. When the ambient light indicates a bright ambient light environment, the electronic device switches to the first recording mode. The electronic device only uses the first camera to record or only receives the video frame images captured by the first camera.

In some embodiments, the at least two recording modes include the first recording mode and the second recording mode. The first recording mode corresponds to the first camera of the at least two cameras. The first camera has the higher resolution than the second camera of the at least two cameras. The second recording mode corresponds to the first camera and the second camera. The second camera has the larger pixel dimension than the first camera.

In some embodiments, during the video recording process, when the ambient light parameter indicates a dark ambient light environment, the electronic device activate the first recording mode and only uses the first camera to record and only receives the video frame images captured by the first camera. When the ambient light indicates a bright ambient light environment, the electronic device switches to the second recording mode. The electronic device uses the first camera and the second camera to record simultaneously and receives the video frame images captured by the first camera and the second camera simultaneously.

In some embodiments, the second recording mode corresponds to the first camera and the second camera. When the current recording mode is the second recording mode, obtaining the images captured by the camera corresponding to the current recording mode includes obtaining the images captured by the first camera and the second camera at the same moment. Displaying based on the obtained images includes merging the image captured by the first camera with the image captured by the second camera at the same moment, and displaying the merged image.

In some embodiments, the second recording mode corresponds to the first camera and the second camera. When the current recording mode is the second recording mode, the electronic device controls the first camera and the second camera to work at the same time and receives the video frame images from the first camera and the second camera simultaneously. The electronic device then merges the image captured by the first camera with the image captured by the second camera at the same moment. The electronic device uses the merged image as the video frame image at the moment, displays it at the display interface, and stores it in the video file.

In some embodiments, merging the image captured by the first camera with the image captured by the second camera at the same moment includes decomposing the image captured by the first camera into a high-frequency part and a low-frequency part, and merging the low-frequency part with the image captured by the second camera at the same moment.

In some embodiments, the high-frequency part of the image refers to a part where frequency changes rapidly and an image intensity changes greatly, that is, the details and noise of the image. The low-frequency part of the image refers to a part where a color gradation changes slowly and continuously and can contain most of image information, that is, an outline of the image. By merging the low-frequency part of the first camera with the image from the second camera, the electronic device can remove noises of the high-resolution image captured by the first camera and save the outline of the high-resolution image. The electronic device also merges the low-frequency part of the first camera with the image captured by the second camera at the same moment. As such, the electronic device can integrate advantages of the high resolution of the first camera and the strong photosensitivity of the second camera. Thus, the electronic device can obtain good quality video images even in a dark environment.

The present disclosure further provides processing device 400.

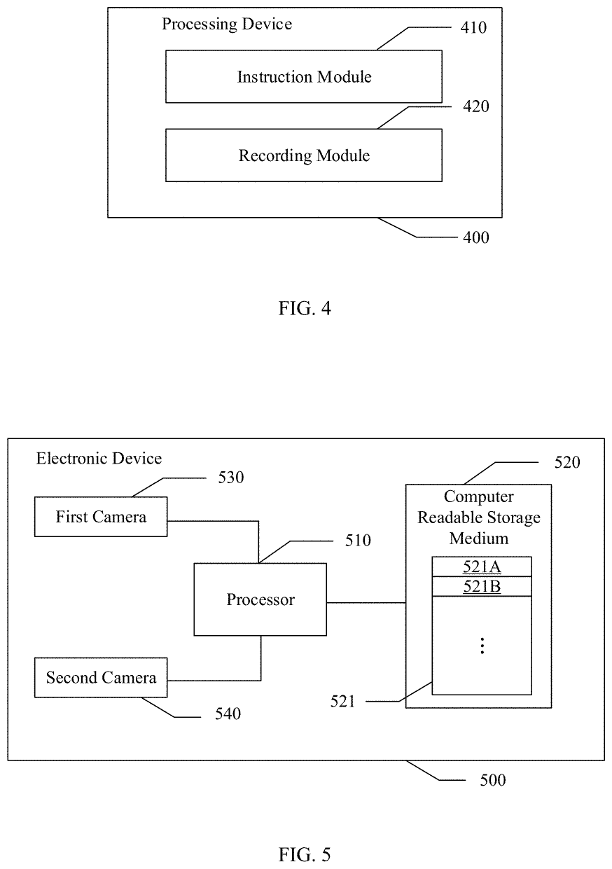

FIG. 4 illustrates a block diagram of a processing device according to some embodiments of the present disclosure.

As shown in FIG. 4, processing device 400 includes instruction module 410 and recording module 420. Instruction module 410 is configured to obtain the video recording instructions. Recording module 420 is configured to respond to the video recording instructions during the video recording process. Recording module 420 is further configured to determine one recording mode as the current recording mode from the at least two recording modes based on the ambient light parameter, obtain the images captured by the camera corresponding to the current recording mode, and display based on the obtained images. Different recording modes correspond with different cameras and camera arrangements of the electronic device.

In some embodiments, instruction module 410, for example, can execute process S210 described above. Recording module 420, for example, can execute process S420 described above. The specification does not repeat the same details herewith.

In some embodiments, the recording module includes a switching module. The switching module is configured to switch the different recording modes based on the different ambient light parameter during the video recording process. As such, the video file generated by responding to the video recording instructions includes the video frame images corresponding to the different recording modes.

In some embodiments, the device embodiments may be made referred to the corresponding contents described above, which are not repeated here.

In some embodiments, the at least two recording modes include the first recording mode and the second recording mode. The first recording mode corresponds to the first camera of the at least two cameras. The first camera has the higher resolution than the second camera of the at least two cameras. The second recording mode corresponds to the second camera, or the second recording mode corresponds to the first camera and the second camera. The second camera has the larger pixel dimension than the first camera.

The electronic device provided by the embodiments of the present disclosure uses the two cameras to record the video based on the ambient light. One camera may have a small pixel dimension but has a high resolution, such that the camera can capture an image with rich contents. The other camera may have a large pixel dimension but has a good night view effect, such that the camera can capture an image with a high brightness level. As such, the electronic device can record a clear video at night or in dark mode, and/or the electronic device can record a clear video when the ambient light changes from high to low or from low to high during the video recording process.

In some embodiments, the device embodiments may be realized according to the corresponding contents described above, which are not repeated herewith.

Any number of modules, sub-modules, units, sub-units according to embodiments of the present disclosure, or at least some functions of any number of them may be implemented in one module. Any one or more of the modules, sub-modules, units, and sub-units according to the embodiments of the present disclosure may be implemented by being divided into multiple modules. Any one or more of the modules, sub-modules, units, and sub-units according to the embodiments of the present disclosure may be at least partially implemented as a hardware circuit, such as a field programmable gate array (FPGA), a programmable logic array (PLA), a system on chip, a system on a substrate, a packaged system, an application specific integrated circuit (ASIC), or any other reasonable means of hardware or firmware that can integrate or package the circuit, or any one or any plurality of suitable combinations of three implementations in form of software, hardware, and firmware. Any one or more of the modules, sub-modules, units, and sub-units according to the embodiments of the present disclosure may be at least partially implemented by a computer program module. The electronic device runs the computer program module to execute corresponding functions.

For example, any number of the various modules and sub-modules can be combined and implemented in one module, or any one of the modules can be divided into multiple modules. In some embodiments, at least part of the functions of one or more of these modules may be combined with at least part of the functions of other modules and implemented in one module. According to some embodiments of the present disclosure, at least one of the various modules and sub-modules may be at least partially implemented as a hardware circuit, such as a field programmable gate array (FPGA), a programmable logic array (PLA), a system on a chip, a system on a substrate , a packaged system, an application specific integrated circuit (ASIC), or any other reasonable means such as hardware or firmware that integrates or packages the circuit, or any one or plurality of suitable combinations of the three implementations in form of software, hardware, and firmware. In some embodiments, at least one of the modules or sub-modules may be at least partially implemented by a computer program module. The electronic device executes the computer program module to implement corresponding functions.

FIG. 5 illustrates a block diagram of an electronic device according to some embodiments of the present disclosure. The electronic device shown in FIG. 5 is merely an example, which should not limit the functions and application scope of the embodiments of the present disclosure.

As shown in FIG. 5, the electronic device includes a processor 510, computer-readable storage medium 520, a first camera 530, and a second camera 540. Electronic device 500 may operate according to the method of the embodiments of the present disclosure.

In some embodiments, processor 510 may include, for example, a general-purpose microprocessor, an instruction set processor, related chipsets, and/or a dedicated microprocessor (e.g., an application specific integrated circuit (ASIC)), etc. Processor 510 may also include an on-board memory for caching purposes. Processor 510 may be a single processing unit or multiple processing units for performing different actions of the method flow according to some embodiments of the present disclosure.

Computer-readable storage medium 520 may be, for example, a non-volatile computer-readable storage medium. Specific examples include but are not limited to a magnetic storage device such as a magnetic tape or a hard disk (HDD), an optical storage device such as an optical disk (CD-ROM), a memory such as a random access memory (RAM) or a flash memory, etc.

Computer-readable storage medium 520 may include computer program 521, which may include codes/computer-executable instructions. Computer program 521 is executed by processor 510 to cause processor 510 to perform the method according to embodiments of the present disclosure or any variation thereof.

Computer program 521 may be used to store, for example, computer program code including computer program modules. For example, the code of computer program 521 may include one or more program modules, for example, including modules of 521A, 521B, etc. In some embodiments, the components and the number of modules vary, and those skilled in the art can use appropriate program modules or program module combinations. These program module combinations are executed by processor 510 to cause processor 510 to perform the method according to embodiments of the present disclosure or any variation thereof.

In some embodiments, processor 510 may interact with the first camera 530 and the second camera 540 to perform the method according to embodiments of the present disclosure or any variation thereof.

In some embodiments, at least one of the modules or sub-modules may be implemented as the computer program module described in FIG. 5. The computer program module is executed by processor 510 to implement corresponding operations described above.

The present disclosure also provides a computer-readable storage medium. The computer-readable storage medium may be included in the device/system described in the above-mentioned embodiments, or may exist alone without being assembled into the device/system. The above-mentioned computer-readable storage medium stores one or more programs. When the above one or more programs are executed, the electronic device implements the method according to embodiments of the present disclosure.

In some embodiments of the present disclosure, the computer-readable storage medium may be a non-volatile computer-readable storage medium, which may include, but is not limited to, a portable computer disk, a hard disk, a random access memory (RAM), and a read-only memory (ROM) , an erasable programmable read-only memory (EPROM or flash memory), a portable compact disk read-only memory (CD-ROM), an optical storage device, a magnetic storage device, or any suitable combination there above. In the present disclosure, the computer-readable storage medium may be any physical medium that contains or stores a program. The program may be used by or in combination with an instruction execution system, device, or device.

The flowchart and block diagrams in the drawings illustrate architectures, functions, and operations of the possible implementations of systems, methods, and computer program products according to embodiments of the present disclosure. Each block in the flowchart or block diagram may represent a module, a program segment, or a part of code, which contains one or more of executable instructions for implementing defined logic functions. In some optional implementations, the functions marked in the blocks may also occur in an order different from that marked in the drawings. For example, two connected blocks may be executed in parallel, in some embodiments, they can also be executed in a reverse order, depending on the functions involved. Each block in the block diagrams or flowcharts, and a combination of blocks in the block diagrams or flowcharts, may be implemented with a dedicated hardware-based system that performs the specified function or operation, or may be implemented with a combination of dedicated hardware and computer instructions.

Those of skill in the art should understand that features described in embodiments and/or claims of the present disclosure may be grouped and/or combined in various ways, even these groups or combinations are not described in the present disclosure. Without departing the spirit and teaching of the present disclosure, the features described in embodiments and/or claims of the present disclosure may be grouped and combined in various ways. All the groups and combinations are within the scope of the present disclosure.

Although the present disclosure has been shown and described by referring to specific exemplary embodiments of the present disclosure, those skilled in the art should understand that without departing from the spirit and scope of the present disclosure as defined by the appended claims and their equivalents, various changes in form and details are made to the present disclosure. Therefore, the scope of the present disclosure should not be limited to the above-described embodiments, but should be determined not only by the appended claims but also by the equivalents of the appended claims.

What is claimed is:

1. A video processing method of an electronic device, comprising:
receiving video recording instructions;
determining a recording mode as a current recording mode from two recording modes based on an ambient light parameter during a video recording process, the two recording modes corresponding to different camera arrangements of the electronic device;
obtaining images captured by a camera corresponding to the current recording mode; and
displaying based on the obtained images.

2. The method of claim 1, wherein based on the ambient light parameter, determining the recording mode as the current recording mode from the two recording modes includes:
based on different ambient light parameters, during the video recording process, switching between different recording modes.

3. The method of claim 2, wherein:
the two recording modes includes a first recording mode and a second recording mode;
the first recording mode corresponds to a first camera of the two cameras, the first camera having a higher resolution than a second camera of the two cameras; and
the second recording mode corresponds to the second camera, the second camera having a larger pixel dimension than the first camera.

4. The method of claim 3, further comprising:
generating a video file based on images corresponding to the different recording modes.

5. The method of claim 3, wherein:
obtaining the images captured by the camera corresponding to the current recording mode includes in response to the current recording mode being the second recording mode, obtaining images captured by the first camera and the second camera at a same moment; and
displaying based on the obtained images includes merging an image captured by the first camera with an image captured by the second camera at the same moment and displaying a merged image.

6. The method of claim 5, wherein merging the image captured by the first camera with the image captured by the second camera at the same moment includes:
decomposing the image captured by the first camera into a high-frequency part and a low-frequency part; and
merging the low-frequency part with the image captured by the second camera at the same moment.

7. A video processing device, comprising:
an instruction circuit, configured to receive video recording instructions; and
a recording circuit, configured to respond to the video recording instructions during a video recording process to:
determine a recording mode as a current recording mode from two recording modes based on an ambient light parameter, the two recording modes correspond to different camera arrangements of the device;
obtain images captured by a camera corresponding to the current recording mode; and
display based on the obtained images.

8. The video processing device of claim 7, wherein the recording circuit includes:
a switching circuit, configured to, based on different ambient light parameters during the video recording process, switch between the different recording modes.

9. The video processing device of claim 8, wherein:
the two recording modes includes a first recording mode ad a second recording mode;
the first recording mode corresponds to a first camera of the two cameras, the first camera having a higher resolution than a second camera of the two cameras; and
the second recording mode corresponds to the second camera, or the second recording mode corresponds to the first camera and the second camera, the second camera having a larger pixel dimension than the first camera.

10. The video processing device of claim 9, wherein the recording circuit is further configured to:
in response to the current recording mode being the second recording mode, obtain images captured by the first camera and the second camera at a same moment; and
display based on the obtained images includes merging an image captured by the first camera with an image captured by the second camera at the same moment and displaying a merged image.

11. The video processing device of claim 10, wherein the recording circuit is further configured to:
decompose the image captured by the first camera into a high-frequency part and a low-frequency part; and
merge the low-frequency part with the image captured by the second camera at the same moment.

12. An electronic device, comprising:
two cameras;
processors; and
a memory, configured to store programs that, when executed by the processors, cause the processors to:
receive video recording instructions; and
respond to the video recording instructions during a video recording process to:
determine a recording mode as a current recording mode from two recording modes based on an ambient light parameter, the two recording modes corresponding to different camera arrangements;
obtain images captured by a camera corresponding to the current recording mode; and
display based on the obtained images.

13. The electronic device of claim 12, wherein the programs further cause the processor to:
based on different ambient light parameters during the video recording process, switch between different recording modes; and
generate a video file includes video frame images corresponding to the different recording modes.

14. The electronic device of claim 12, wherein:
the two recording modes includes a first recording mode and a second recording mode;
the first recording mode corresponds to a first camera of the two cameras, the first camera having a higher resolution than a second camera of the two cameras; and
the second recording mode corresponds to the second camera, the second camera having a larger pixel dimension than the first camera.

15. The electronic device of claim 14, wherein the programs further cause the processor to:
in response to the current recording mode being the second recording mode, obtain images captured by the first camera and the second camera at a same moment; and
display based on the obtained images includes merging an image captured by the first camera with an image captured by the second camera at the same moment and displaying a merged image.

16. The electronic device of claim 15, wherein the programs further cause the processor to:
decompose the image captured by the first camera into a high-frequency part and a low-frequency part; and
merge the low-frequency part with the image captured by the second camera at the same moment.
